(19) United States
(12) Patent Application Publication
(10) Pub. No.: US 2017/0217674 A1
(43) Pub. Date: Aug. 3, 2017

(54) TRASH COMPACTING SYSTEM AND APPARATUS

(71) Applicants: Samuel Leggett, Glenwood, IL (US); Marie LeGrand, Glenwood, IL (US)

(72) Inventors: Samuel Leggett, Glenwood, IL (US); Marie LeGrand, Glenwood, IL (US)

(21) Appl. No.: 15/421,410

(22) Filed: Jan. 31, 2017

Related U.S. Application Data
(60) Provisional application No. 62/289,323, filed on Jan. 31, 2016.

(51) Int. Cl. B65F 1/00; B30B 15/00; B30B 15/16; B30B 5/02

(52) U.S. Cl. CPC B65F 1/00; B30B 5/02; B30B 15/0052; B30B 15/168; B30B 15/0094

(57) ABSTRACT

A trash compacting apparatus comprising a container, an air pump, one or more inflatable air bladders, a controller unit, and an interface unit is disclosed herein. The apparatus may further comprise an air distributor. The apparatus may operate as a standard trash container and may further comprise a lid. The apparatus may be operated by the user or by a programmable controller unit to inflate the air bladders, thereby compressing trash contained within the apparatus and reducing the total volume of the trash.

### CROSS-REFERENCE TO RELATED APPLICATIONS

This application claims the benefit of, and priority to, U.S. Provisional Patent Application Ser. No. 62/289,323, filed Jan. 31, 2016, the entire disclosure of which is incorporated herein by reference.

### BACKGROUND

Field of the Invention

The present disclosure relates to a system and apparatus for compacting trash in a household application.

Description of the Related Art

There has long been an interest in reducing landfill volume. Methods currently in use to accomplish this goal include reducing the amount of trash generated, increasing recycling of materials that may be recycled, and compressing trash volume.

U.S. Pat. No. 6,135,637 discloses a compressible trash bag having a series of vertical air slots made up of fine perforations on the upper portions of both walls that break open from stress of compression to allow excess air inside the bag to discharge to the outside atmosphere.

U.S. Pat. No. 5,690,248 discloses a nested bag assembly for containing material requiring handling and compaction that reduces the risk of rupture during compaction.

JP08002604, Chinese Patent Appl. Publ. No. 2,579,843, United Kingdom Patent Appl. Publ. No. 2,447,612, and United Kingdom Patent Appl. Publ. No. 2,470,578 disclose systems and apparatuses that use inflatable air bags to compact trash.

While the above efforts have attempted to solve various problems with respect to trash compacting, there remains a need for a simple, low maintenance, inexpensive trash compacting system and apparatus that is suitable for home use.

### SUMMARY

A trash compacting apparatus comprising a container, an air pump, one or more inflatable air bladders, a controller unit, and an interface unit is disclosed herein. The apparatus may further comprise an air distributor. The apparatus may operate as a standard trash container and may further comprise a lid. The apparatus may be operated by the user or by a programmable controller unit to inflate the air bladders, thereby compressing trash contained within the apparatus and reducing the total volume of the trash.

### BRIEF DESCRIPTION OF THE DRAWINGS

FIG. 1 shows an embodiment of the trash compacting apparatus.

FIG. 2 shows an embodiment of the air pump.

FIG. 3 shows an embodiment of an air bladder.

FIG. 4 shows a side view of an embodiment of an air bladder.

FIG. 5 shows an embodiment of an air distributor unit.

FIG. 6 shows a side view of an embodiment of an air distributor unit.

FIG. 7 shows an embodiment of the air bladders.

FIG. 8 shows a top view of an embodiment of the air bladders.

FIG. 9 shows an embodiment of the air pump connected to the distributor, wherein the distributor is connected to an air bladder and to a pressure sensor, and wherein the load plate is on top of the distributor.

FIG. 10 shows a load plate connected to load sensors.

FIG. 11 shows an embodiment of a load sensor.

FIG. 12 shows an embodiment of a pressure sensor.

### DETAILED DESCRIPTION OF THE ILLUSTRATED EMBODIMENTS

A trash compacting apparatus comprising a container, an air pump, one or more inflatable air bladders, a controller unit, and an interface unit is disclosed herein. The apparatus may further comprise an air distributor, a load plate, a load sensor, and a pressure sensor. The apparatus may operate as a standard trash container and may further comprise a lid. The apparatus may be operated by the user or by a programmable controller unit to inflate the air bladders, thereby compressing trash contained within the apparatus and reducing the total volume of the trash.

Design

Some embodiments of the compacting trash apparatus disclosed herein generally mimic ordinary trash containers, and comprise a container for holding trash, a base, an air pump, air bladders, an air distributor, a load plate, a load sensor, and a pressure sensor. Some embodiments may further comprise a lid. The trash compacting apparatus may use an external power source, such as electricity or battery power. In some embodiments, the trash compacting apparatus may be electrically powered and further comprise an electrical pump. The electrical pump inflates air bladders inside the container, thereby compressing the trash and reducing the total trash volume. This allows the user to add more trash into the container. In some embodiments, the trash compacting apparatus may be powered by a pneumatic system, wherein the apparatus may be connected to an external air pump and may use a series of valves to control the pressure in the air bladders.

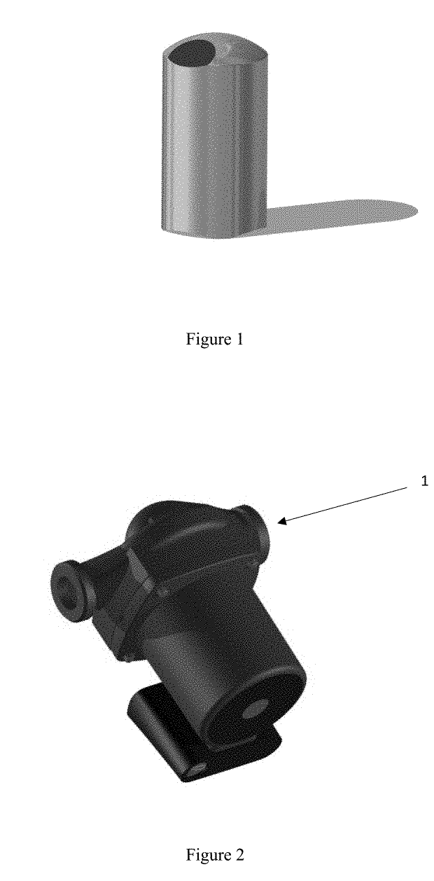

FIG. 1 illustrates an embodiment of the trash compacting apparatus with a lid. The container shown in FIG. 1 is cylindrical, though any desired geometry may be used.

FIG. 2 illustrates an air pump comprising a connector (1) that may be used with the embodiment in FIG. 1.

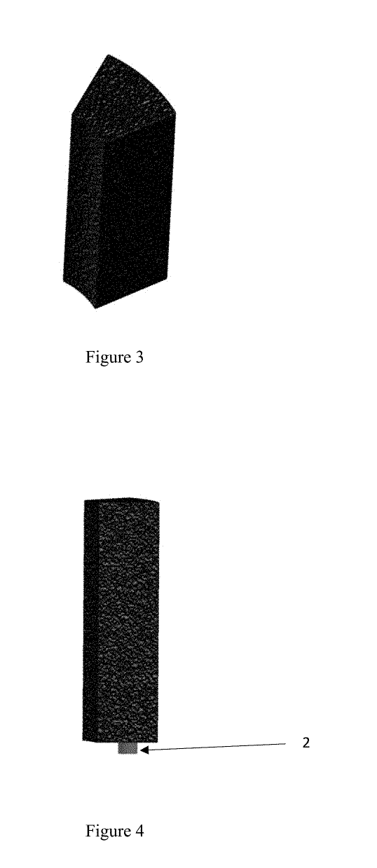

FIG. 3 illustrates an embodiment of an air bladder with a circular trapezoid cross-section.

FIG. 4 illustrates a side view of the embodiment of the air bladder in FIG. 3 that includes a nozzle (2) that may be used to connect the air bladder to a controller unit.

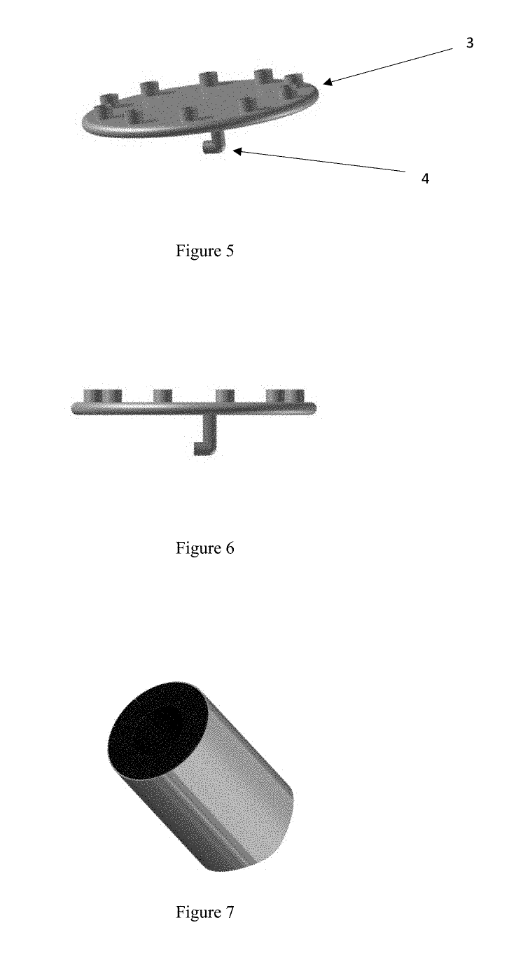

FIG. 5 illustrates an embodiment of an air distributor, which includes an air distributor nozzle plug (3) and an air distributor pipe (4) to connect the air distributor to the air pump.

FIG. 6 illustrates a side view of the air distributor.

FIG. 7 illustrates multiple air bladders inside the trash compacting apparatus, wherein some or all of the air bladders may be inflated to reduce the total volume of the container. The air bladders are set around the circumference of the cylindrical container shown in FIG. 7, and when inflated they will compress from the sides of the container. In some embodiments, one or more additional air bladders may be deployed at the top of the container. In some embodiments, one or more additional air bladders may be deployed at the bottom of the container. In some embodiments, one or more additional air bladders may be deployed at the top and bottom of the container. Where the container is non-cylindrical, other configurations for deployment of the air bladders may be used.

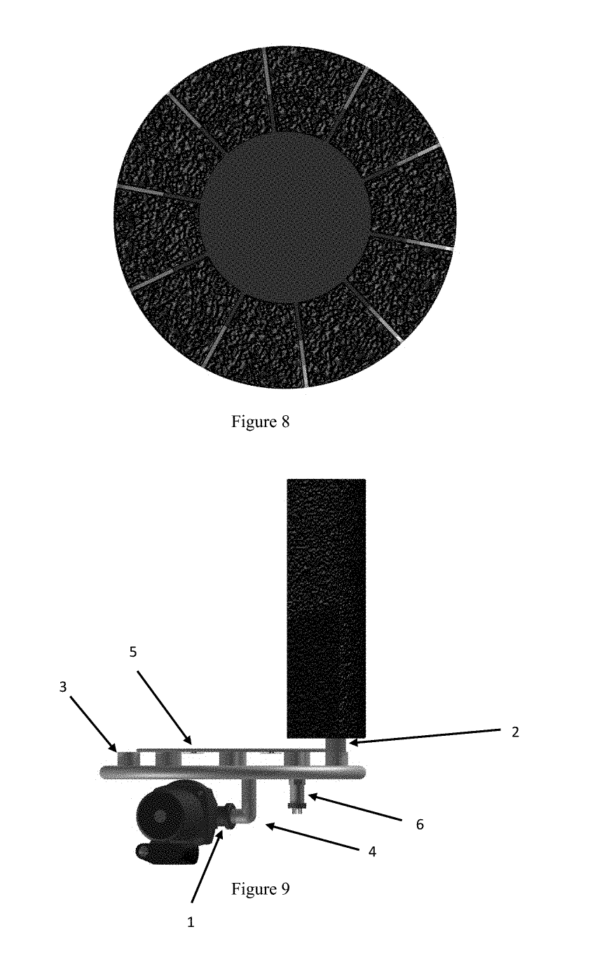

FIG. 8 illustrates a top view of the air bladders deployed inside the container. In some embodiments, the air bladders may have gaps between them.

FIG. 9 illustrates an embodiment wherein an air pump connector (1) is connected to an air distributor pipe (4), an air bladder nozzle (2) is connected to an air distributor nozzle plug (3), a pressure sensor (6) is connected to an air distributor, and a load plate (5) is situated on top of the air distributor to form the trash compacting components of the trash compacting apparatus.

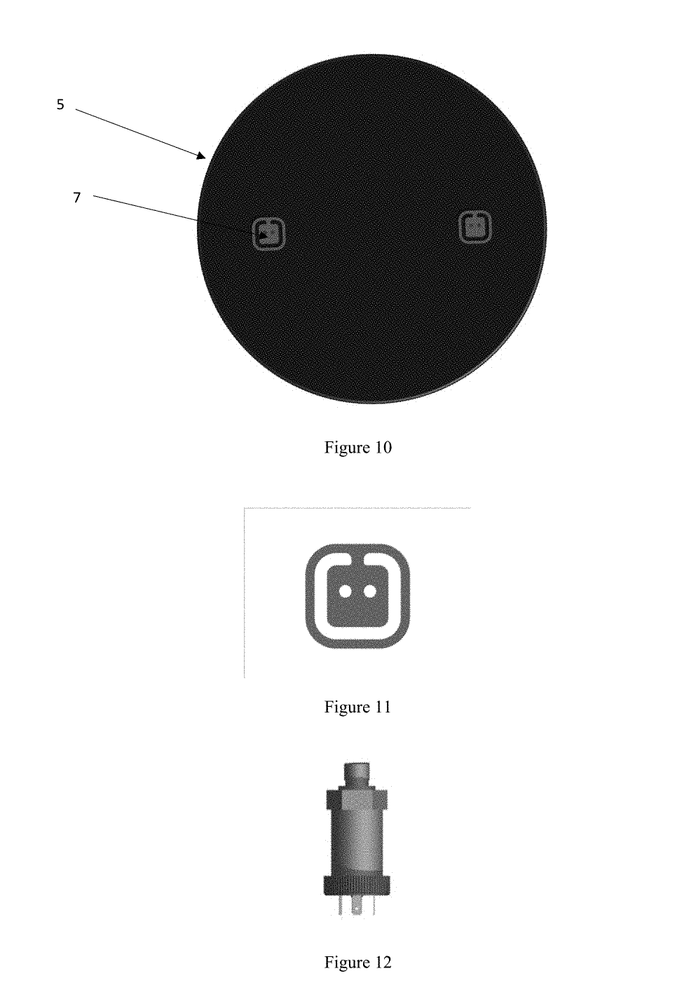

FIG. 10 illustrates an embodiment wherein a load sensor (7) is connected to a load plate (5).

FIG. 11 illustrates an embodiment of a load sensor.

FIG. 12 illustrates an embodiment of a pressure sensor.

In some embodiments, the air bladders may be shaped as circular trapezoids, wherein multiple air bladders may cover the circumference of a circular container. Each air bladder may include a nozzle that plugs into an air distributor, and may include a metallic or polymer layer to protect the air bladder from being punctured during normal operation and to improve its durability.

A primary air pump may be used to inflate the air bladders, wherein the primary air pump pumps air into the air bladder, increasing the pressure within each air bladder and causing each air bladder to expand. In some embodiments, an external air pump or centralized pneumatic system may be employed.

In some embodiments, each air bladder may further comprise a valve that may be closed when the air bladder is inflated and may be opened to the atmosphere to release air on account of the natural pressure difference between the air bladder and the atmosphere.

In some embodiments, a secondary air pump may also be used to deflate the air bladders after use to compact trash, wherein the secondary air pump removes air from the air bladders and vents it into the atmosphere and wherein the secondary air pump may be the same air pump as the primary air pump or may alternatively be a different air pump than the primary air pump. In some embodiments, a vacuum pump may be used to deflate the air bladders after use to compact trash.

In some embodiments, an air distributor may be used to distribute air between separate air bladders, allowing the apparatus to maintain approximately equal air pressure in all the air bladders and thereby preventing a given air bladder from exceeding its pressure limit. In some circumstances, this may promote more efficient operation of the system by adjusting for trash objects that may be limiting a specific air bladder from inflating by inflating surrounding air bladders instead of the air bladder that has been obstructed by a trash object.

In some embodiments, a pressure sensor may be used to measure the air pressure in the trash compacting apparatus to regulate and control the air pressure in the system.

In some embodiments, a load sensor may be used to measure the weight of trash contained in the container to determine whether the weight has reached or exceeded a predetermined threshold.

The container may be configured to use disposable or reusable garbage bags.

In some embodiments, a controller unit may control the timing of compression, air pump power consumption, and other system parameters that promote the successful and efficient operation of the trash compacting apparatus. The controller unit may also present information to the user via an interface, such as a visual display, or an auditory, tactile, or other interface. The controller unit may be connected to the Internet to present information to the user via electronic mail or one or more other forms of electronic communication. The controller unit may also receive information from the user to determine how and when to operate the system.

Operation

In some embodiments, all the air bladders are deflated and deployed toward the sides of the container to allow for maximum volume for trash input. After trash is inserted into the container, the user may close and lock the lid and activate the trash compacting apparatus. This process may also be automated, for example at a certain time of day. In some embodiments, the lid may have an automatic locking system to improve safety and functionality. Upon completion of trash compaction, the air bladders may be deflated again as described above, and the lid may be unlocked.

The disclosure and examples above are intended to be illustrative and are not intended to limit or otherwise restrict the invention. Numerous variations and modifications will become apparent to those skilled in the art upon full appreciation of the above disclosure.

All references cited herein are expressly incorporated by reference.

What is claimed is:

1. A trash compacting apparatus comprising:
a. a container;
b. a primary pump;
c. one or more inflatable air bladders; and
d. a controller unit.

2. The trash compacting apparatus of claim 1 further comprising an air distributor, wherein the air distributor distributes air between separate air bladders to maintain approximately equal pressure in each air bladder.

3. The trash compacting apparatus of claim 1 further comprising a lid.

4. The trash compacting apparatus of claim 2 wherein the controller unit is programmable.

5. The trash compacting apparatus of claim 2 wherein the controller unit may be operated by a user.

6. The trash compacting apparatus of claim 2 further comprising a base, a load plate, and a load sensor.

7. The trash compacting apparatus of claim 2 further comprising a pressure sensor.

8. The trash compacting apparatus of claim 6 further comprising a pressure sensor.

9. The trash compacting apparatus of claim 1 wherein the primary pump is an electrical pump.

10. The trash compacting apparatus of claim 1 wherein the primary pump is an air pump and wherein the one or more air bladders each further comprises a valve to enable control of the pressure therein.

11. The trash compacting apparatus of claim 8 wherein the primary pump is an air pump and wherein the one or more air bladders each further comprises a valve to enable control of the pressure therein.

12. The trash compacting apparatus of claim 10 further comprising a secondary pump, wherein the primary pump inflates the one or more air bladders and the secondary pump deflates the one or more air bladders.

13. The trash compacting apparatus of claim 12 wherein the secondary pump is an air pump.

14. The trash compacting apparatus of claim 12 wherein the secondary pump is a vacuum pump.

15. The trash compacting apparatus of claim 11 further comprising a secondary pump, wherein the primary pump inflates the one or more air bladders and the secondary pump deflates the one or more air bladders.

16. The trash compacting apparatus of claim 15 wherein the secondary pump is an air pump.

17. The trash compacting apparatus of claim 15 wherein the secondary pump is a vacuum pump.

18. The trash compacting apparatus of claim 11 wherein the primary pump inflates and deflates the one or more air bladders.

19. The trash compacting apparatus of claim 9 wherein the primary pump inflates and deflates the one or more air bladders.

20. The trash compacting apparatus of claim 8 further comprising an interface unit, wherein the controller unit relays information regarding the apparatus to the interface unit.
